(19) United States
(12) Patent Application Publication
(10) Pub. No.: US 2025/0189047 A1
(43) Pub. Date: Jun. 12, 2025

(54) Fluid Valve, Cooling System Of A Motor Vehicle, And Motor Vehicle Having Such A Fluid Valve

(71) Applicant: ECO Holding 1 Gmbh, Marktheidenfeld (DE)

(72) Inventors: Fatih Dogan, Nürtingen (DE); Philipp Harbusch, Kusterdingen (DE); Stephan Wanner, Biberach (DE)

(73) Assignee: ECO Holding 1 Gmbh, Marktheidenfeld (DE)

(21) Appl. No.: 18/844,636

(22) PCT Filed: Mar. 10, 2023
(86) PCT No.: PCT/EP2023/056186

§ 371 Date: Sep. 6, 2024

(30) Foreign Application Priority Data
Mar. 11, 2022 (DE) 10 2022 105 815.8

(51) Int. Cl. F16K 11/087; B60K 1/00; F16K 25/00

(52) U.S. Cl. CPC F16K 11/0873; F16K 25/00; B60K 2001/003

(57) ABSTRACT

The invention relates to a fluid valve, in particular for a coolant circuit of a motor vehicle, having a valve body (10) which is arranged rotatably in a valve housing (30), wherein the valve housing (30) has a plurality of flow channels (34) and a sealing arrangement (400) is provided between each of the flow channels (34) and the valve body (10), which sealing arrangement comprises a sliding seal (40) and an elastic seal (50), wherein the elastic seal (50) is arranged between the valve housing (30) and the sliding seal (40) in such a way that the sliding seal (40) is tensioned against the valve body (10). The invention is characterized in that the sliding seal (40) has an L-shaped cross section with a support flange (41) and a pipeline section (42), wherein the pipeline section (42) delimits a fluid channel (60) in an annular manner and the support flange (41) extends radially outwards beyond an outer circumference of the pipeline section (42).

### TECHNICAL FIELD

The invention relates to a fluid valve according to the preamble of patent claim 1. Furthermore, the invention relates to a cooling system of a motor vehicle and a motor vehicle having such a fluid valve.

### PRIOR ART

Fluid valves of the type mentioned at the outset and corresponding fluid devices are generally known and are used, for example, to switch or divert cooling fluids within so-called thermal management modules, in particular of hybrid vehicles or electrically operated vehicles.

From EP 4 083 480 A2, for example, a fluid valve arrangement is known which comprises a valve housing which accommodates a valve body. The valve housing has a plurality of connection openings in which a sealing arrangement is provided. The sealing arrangement seals the connection opening with respect to the valve body.

The known sealing arrangement comprises two elements, namely an elastic sealing element which bears directly against the valve body, and a fastening element with which the sealing element is tensioned against the valve body. The fastening element is anchored in the connection opening of the valve housing via latching connections.

In the known fluid valve arrangement, the sealing element has a V-shaped cross-sectional profile, wherein the tip of the cross-sectional profile presses against the valve body. This has the disadvantage that the contact surface with respect to the valve body is significantly increased in the case of a higher contact pressure. This leads to high wear of the sealing element, in particular in the case of frequent actuation of the valve body. In addition, the assembly of the known sealing arrangement is relatively complex since the sealing element is firstly to be fixedly connected to the fastening element in order to avoid incorrect positioning during assembly.

It is an object of the invention to provide a fluid valve which belongs to the technical field mentioned at the outset and which has an easily mountable sealing arrangement which additionally permits permanently smooth operation of the fluid valve. Furthermore, it is an object of the invention to specify a cooling system of a motor vehicle and a motor vehicle having such a fluid valve.

The solution of the object is defined by the features of claim 1. According to the invention, a fluid valve having a valve body is provided, which valve body is arranged rotatably in a valve housing. The valve housing has a plurality of flow channels. A sealing arrangement is provided between each of the flow channels and the valve body, which sealing arrangement comprises a sliding seal and an elastic seal, wherein the elastic seal is arranged between the valve housing and the sliding seal in such a way that the sliding seal is tensioned against the valve body. According to the invention, the sliding seal has an L-shaped cross section with a support flange and a pipeline section, wherein the pipeline section delimits a fluid channel in an annular manner. The support flange extends radially outwards beyond an outer circumference of the pipeline section.

The advantage of the invention is that the L-shaped configuration with the support flange permits radial support of the sliding seal. In particular, the sliding seal can be supported radially outwards on the inner side of the valve housing, with the result that the stability of the sliding seal, which is subjected to shear forces as a result of the rotation of the valve body, is improved. It is thus also ensured that the sliding seal retains its shape and position well.

The L-shaped cross section of the sliding seal has the further advantage that the contact with the valve body, which is preferably equipped with a spherical lateral surface, can be delimited by area, as a result of which the smoothness of the fluid valve can be permanently ensured. In particular, wear of the sliding seal is also reduced.

Furthermore, the support flange can have, on an annular face which faces the pipeline section, an annular groove for radially securing the elastic seal. The elastic seal, which applies a prestress to the sliding seal in order to force the latter against the valve body, is thus secured radially on the sliding seal by the annular groove. Specifically, the elastic seal can engage in the annular groove, wherein a radial movement of the elastic seal is delimited by the annular groove. In particular, a groove flank which delimits the annular groove on an outer circumference prevents the elastic seal from being displaced or bent radially outwards, with the result that the elastic seal is held continuously in contact with the sliding seal. The annular groove is preferably formed in a face which is oriented perpendicularly to the longitudinal axis of the sealing arrangement.

In a preferred embodiment of the invention, it is provided that the support flange has a chamfer with a chamfer edge which forms a linear contact with the valve body. Preferably, there is exclusively the linear contact with the valve body. In this way, the contact between the sliding seal and the support flange is delimited to a great extent by area, with the result that relatively low frictional forces act during a rotation of the valve body. The smoothness of the fluid valve is thus ensured. At the same time, however, the linear contact is sufficient to ensure good sealing, in particular fluid sealing. As a result of the elastic seal clamping the sliding seal against the valve body, tolerance compensation is provided and permanent sealing is ensured.

The chamfer edge can be formed between the chamfer and a side face of the support flange which faces the valve body. It is preferably provided that the side face is oriented perpendicularly to a longitudinal axis of the sliding seal. The side face which is oriented perpendicularly to the longitudinal axis of the sliding seal contributes to a radial transmission of force from the sliding seal to an inner face of the valve housing. Such a radial or perpendicular transmission of force has a particularly good supporting effect.

In a preferred embodiment of the invention, an annular edge is formed between the chamfer and an inner circumferential face of the pipeline section, wherein the annular edge is arranged at a distance from the valve body. The chamfer can consequently be delimited by the chamfer edge, on the one hand, and the annular edge, on the other hand. In any case, the chamfer preferably extends from the side face of the support flange to the inner circumferential face of the pipeline section. In this case, the chamfer can assume an angle which runs substantially tangentially with respect to a spherical circumferential face of the valve body. The distance between the annular edge and the valve body ensures in any case that there is linear contact between the sliding seal and the valve body via the chamfer edge. The contact between the sliding seal and the valve body is thus reduced to what is necessary, wherein what is necessary can be, in particular, a linear contact which, on the one hand, ensures sufficient fluid sealing and, on the other hand, exerts low friction on the valve body.

The support flange preferably has a radial outer circumferential face which is supported against the valve housing. The radial outer circumferential face can be oriented substantially perpendicularly or at right angles to the side face and preferably concentrically with respect to the longitudinal axis of the sliding seal. The shape of the outer circumferential face preferably corresponds to the inner contour of the valve housing at the location at which the sliding seal is arranged. In particular, the support flange can be supported on an inner circumferential face of the valve housing. In this case, planar contact is advantageous in order to transmit the supporting forces sufficiently to the valve housing.

The elastic seal can surround the pipeline section in an annular manner. The annular arrangement of the elastic seal around the pipeline section has the advantage that the elastic seal is positioned well on the sliding seal and its assembly is of correspondingly simple configuration. For the assembly, the elastic seal is merely to be pushed onto the pipeline section. Further assembly steps, in particular a firmly bonded or force-fitting connection between the elastic seal and the sliding seal, are not necessary, but can additionally be provided.

In a preferred embodiment of the invention, the elastic seal has a predetermined bending point. In order to form the predetermined bending point, the elastic seal can have, on an inner circumferential face, an annularly encircling depression and/or, on an outer circumferential face, an annularly encircling curvature. The predetermined bending point has the effect that, during the arrangement in the valve housing, the elastic seal curves outwards and exerts a clamping force on the sliding seal in a spring-like manner. For this purpose, the elastic seal is positioned in the valve housing such that it is supported with one end in the annular groove of the sliding seal and bears with the other axial end against the valve housing. The distance between the annular groove, in particular the bottom of the annular groove, and the valve housing is preferably smaller than the width of the elastic seal. The elastic seal consequently has to be compressed in order to fill this space. In this case, the predetermined bending point serves the purpose of the elastic seal curving outwards in a targeted manner and thus ensuring that a uniform clamping force is exerted on the sliding seal over the entire circumference of the seal arrangement.

Furthermore, the elastic seal can have, at an end which faces away from the support flange, a radially outwardly directed bead. In other words, the longitudinal axial ends of the elastic seal can be of different configuration. In this respect, it is possible to speak of an elastic seal of asymmetrical configuration. The outwardly directed bead at the end of the elastic seal which faces away from the support flange brings about improved support of the elastic seal on the valve housing. It has been found that such support, on the one hand, simplifies assembly and, on the other hand, also permanently effects a uniform clamping force on the sliding seal.

In a preferred embodiment, the inner circumferential face of the elastic seal widens conically at an end which faces away from the support flange and towards the valve housing. In particular, the inner circumferential face of the elastic seal can exhibit a conical widening in the region in which the bead is arranged on the outer circumferential face. The conically widened inner circumferential face and the bead can interact in this respect in order to achieve improved support of the elastic seal on the valve housing.

Furthermore, it is preferred if the elastic seal has a more elastic material than the sliding seal. In this case, the elasticity relates in particular to the spring effect of the elastic seal. In particular, the elastic seal can have a spring-like effect with a flat spring characteristic. In this way, the sliding seal is prestressed axially. By contrast, the sliding seal is preferably equipped with a lower elasticity. In particular, the sliding seal has a material which exhibits low wear as a result of the rotation of the valve body. At the same time, the sliding seal should have a material which ensures good fluid sealing. Since the sliding seal slides on the valve body when the latter rotates, the sliding seal is also referred to as a dynamic sliding seal.

An independent aspect of the invention relates to a cooling system of a motor vehicle, in particular of a passenger motor vehicle, having a fluid valve described above. The motor vehicle, in particular the passenger motor vehicle, may be a battery-electric motor vehicle.

Furthermore, within the context of the application, a motor vehicle having such a cooling system and/or the fluid valve described above is disclosed and claimed as a further independent aspect.

The present application also discloses a fluid valve for a fluid system of a motor vehicle, wherein the fluid valve has at least two connection openings for the inflow and/or outflow of fluid, a valve housing and a valve body which is rotatable about an axial longitudinal axis in the valve housing and has at least one connecting channel for connecting at least two connection openings depending on the position of the valve body. For sealing between the valve body and the valve housing in the region of the connection openings, a two-part sealing arrangement is provided in each case, which sealing arrangement has a dynamic sliding seal and an elastic seal. Preferably, a height/length ratio of the elastic seal in the non-tensioned state is less than 0.5.

The low height/length ratio of the elastic seal permits a very flat spring characteristic which permits a low friction moment between the sealing arrangement and the valve body. A rotation of the valve body even under different conditions, for example as a result of different fluid pressures or different temperatures, is thus ensured.

According to an advantageous embodiment, the sliding seal is provided for sealing abutment against the valve body and the elastic seal is provided for sealing abutment against the sliding seal and the valve housing or a connection piece which is connected to the valve housing, such that, in the tensioned state, the elastic seal bears in a sealing manner axially between the sliding seal and the valve housing or a connection piece which is connected to the valve housing. As a result, the sealing of the fluid path through the valve body and the valve housing can be ensured and a fluid bypass around the valve body can be prevented.

Preferably, the sliding seal is substantially L-shaped in cross section and the elastic seal is substantially C-shaped in cross section. The sliding seal can thus offer suitable supporting or guide faces for the valve body and for the elastic seal. By contrast, the elastic seal is substantially C-shaped or in other words crescent-shaped. In addition to the elastic axial compression, the crescent-shaped shape additionally permits elastic bending, as a result of which the sealing action is improved.

Furthermore, the valve body can be provided so as to be able to be centred via a plurality of sliding seals, as a result of which the rotation of the valve body is improved. According to an advantageous development of the fluid valve, the valve body, the valve housing and a cover which closes the valve housing can each have complementary means for preventing tilting of the valve body, such that tilting of the valve body can be ruled out or maximum tilting which is harmless to the function can be defined.

According to different embodiments of the invention, the connecting channel can be of straight or arcuate configuration. The shape or number of the connecting channels are dependent on the use of the fluid valve or on the arrangement of the connection openings. These can be formed axially on the valve housing. A connection opening can additionally or alternatively be arranged radially on the valve housing.

According to an advantageous development, the valve body can be arranged in a distributor plate, wherein connection pieces for the connection openings or continuing channels can be provided integrated into the distributor plate. In this case, the distributor plate forms the valve housing or alternatively the cover.

Furthermore, a fluid device having a fluid valve and an actuator, which is connected to the fluid valve, for actuating the fluid valve for a fluid system of a motor vehicle is proposed.

According to an advantageous embodiment of the fluid device, the actuator has an electric motor having an engine output shaft and a transmission for transmitting a torque of the engine output shaft to an actuator output wheel which is configured for actuating the fluid valve. The actuator output wheel and a drive shaft of the valve body can be connected in a form-fitting manner.

The fluid device can be used as a multi-way valve and/or as a cooling water valve of a vehicle.

### BRIEF DESCRIPTION OF THE DRAWINGS

The above-described, different and exemplary features can be combined with one another according to the invention, insofar as this is technically meaningful and suitable. Further features, advantages and embodiments of the invention emerge from the following description of the exemplary embodiments illustrated in the figures. In the figures:

FIG. 1 shows an exploded illustration of a fluid valve according to the invention according to a preferred exemplary embodiment;

FIG. 2 shows a longitudinal sectional view of the fluid valve according to FIG. 1;

FIG. 3 shows a longitudinal sectional view of a detail of the fluid valve according to FIG. 1; and

FIG. 4 shows a longitudinal sectional view of a detail of a fluid valve according to the invention according to a further preferred exemplary embodiment.

In principle, identical parts are provided with identical reference signs in the figures.

### WAYS OF CARRYING OUT THE INVENTION

FIG. 2 shows a longitudinal section of a fluid valve according to the invention which can be provided, for example, as part of a fluid device as a multi-way valve and/or as a cooling water valve for a fluid system of an at least partially electrically operated motor vehicle.

An actuator, which is not illustrated and is connected to the fluid valve, for actuating the fluid valve can be configured, for example, as an electric motor having an engine output shaft and a transmission for transmitting a torque of the engine output shaft to an actuator output wheel which is configured for actuating the fluid valve. The actuator output wheel and a drive shaft 14 of the valve body can be connected simply in a form-fitting manner. The electric motor can be configured as a brushless stepping motor in a space-saving manner next to the transmission.

It is likewise possible for the stepping motor to have a first and a second stator and a first and a second rotor, wherein a connecting element connects the two rotors for torque transmission, as a result of which a space-saving motor with improved heat distribution can be formed.

The fluid valve for a fluid system of a motor vehicle has at least two connection openings 34 for the inflow and/or outflow of fluid, a valve housing 30 and a single-part or multi-part valve body 10 which is rotatable about an axial longitudinal axis 13 in the valve housing 10 and has at least one connecting channel 16 for connecting at least two connection openings 34 depending on the position of the valve body 10. Fluid flows, i.e. coolant flows, can be distributed into different regions of the cooling system of the vehicle, wherein switching of positions between open and closed connections takes place. A continuous mixing of fluid flows for temperature regulation is likewise possible.

The fluid valve shown in the figures has four radial connection openings 34, wherein a connection piece 36 connected in each caseto the valve housing 30 is arranged on each connection opening 34. The connection can be produced, for example, in a firmly bonded manner.

For sealing between the valve body 10, which is formed substantially spherical here, and the valve housing 30 in the region of the connection openings 34, a two-part sealing arrangement is provided, which sealing arrangement has a dynamic sliding seal 40 and an elastic seal 50.

The sliding seal 40 composed of a plain bearing material is annular and substantially L-shaped in cross section and, with the legs, offers suitable supporting or guide faces for the valve body 10 and for the elastic seal 50, wherein a face which faces the valve body 10 is adapted to the shape of the valve body 10.

By contrast, the elastic seal 50 is annular and substantially C-shaped in cross section or in other words crescent-shaped and, in addition to the elastic axial compression, additionally permits elastic bending, as a result of which the sealing action can be improved.

A height/length ratio of the elastic seal 50 in the non-tensioned state is less than 0.5, for example approximately 0.3 or 0.2. The low height/length ratio of the elastic seal 50 permits a very flat spring characteristic which permits a low friction moment between the sealing arrangement 400 and the valve body 10. A rotation of the valve body 10 even under different conditions, for example as a result of different fluid pressures or different temperatures, is thus ensured.

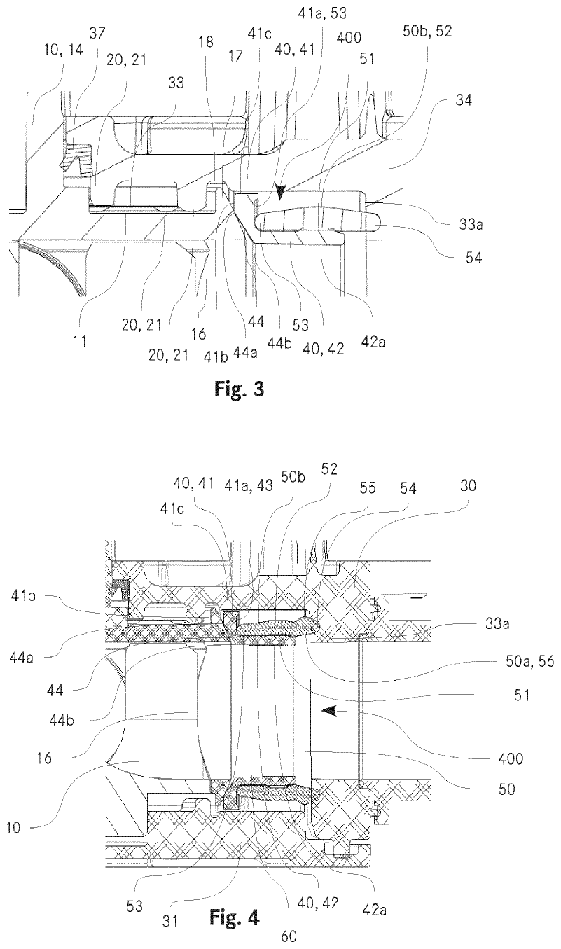

As is clear from FIG. 3 which shows the elastic seal 50 in an untensioned state, the sliding seal 40 is provided for sealing abutment against the valve body 10 and the elastic seal 50 is provided for sealing abutment against the sliding seal 40 and the valve housing 30 or a connection piece 36 which is connected to the valve housing 30, such that the elastic seal 50 bears in a sealing manner axially between the sliding seal 40 and the valve housing 30 or a connection piece 36 which is connected to the valve housing 30 in the tensioned state. As a result, the sealing of the fluid path through the valve body 10 and the valve housing 30 can be ensured and a fluid bypass around the valve body 30 can be prevented.

If two connection openings 34 are provided diametrically opposite in each case, the valve body 10 can be centred via the sliding seals 40, as a result of which the rotation of the valve body 10 is improved.

The valve housing 30 is closed in a fluid-tight manner by means of a cover 31, wherein the cover 31 is welded onto the valve housing 30, for example. For preventing tilting of the valve body 10, the valve body 10 and the valve housing 30 and the cover 31 can each have complementary means, such that tilting of the valve body 10 can be ruled out or maximum tilting which is harmless to the function can be defined. These means are formed, for example, as circumferential projections 17 and circumferential recesses 18 which can be seen in FIG. 3.

Depending on the use of the fluid valve, the connecting channel 16 can be of straight or arcuate configuration. A plurality of connecting channels 16 can likewise be formed into the valve body 10, wherein the shape or number of the connecting channels 16 depend on the use of the fluid valve or on the arrangement of the connection openings 34.

According to an embodiment which is not illustrated, the valve body 10 can be arranged in a distributor plate, wherein connection pieces for the connection openings 34 or continuing channels can be provided integrated into the distributor plate. In this case, the distributor plate forms the valve housing 30 or alternatively the cover 31.

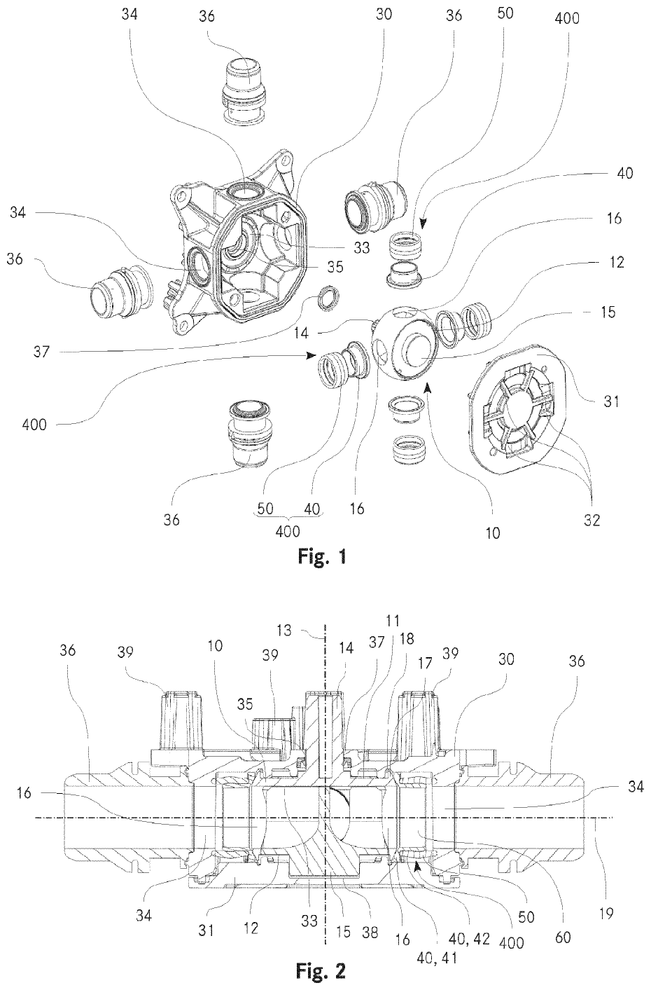

The exploded illustration according to FIG. 1 shows the individual components of the fluid valve in detail. The fluid valve comprises in particular the valve body 10 and the valve housing 30. The valve body 10 is preferably formed in one piece or monolithically. The valve housing 30 can be formed in one piece or be composed of a plurality of parts.

The valve body 10 has an upper side 11 and a lower side 12. The upper side 11 and the lower side 12 run substantially parallel to one another and are arranged opposite one another. The upper side 11 and the lower side 12 are connected by a lateral surface which is curved outwards. Specifically, the lateral surface is curved outwards in a spherical manner. The valve body 10 thus forms part of a ball valve.

In order to be able to conduct fluid flows in different directions, the valve body 10 comprises connecting channels 16 which extend through the valve body 10. The connecting channels 16 have valve openings which interrupt the lateral surface. The connecting channels 16 preferably extend in a plane which is oriented parallel to the upper side 11 and to the lower side 12.

The valve body 10 furthermore comprises an axis of rotation 13 about which the valve body 10 can rotate in the valve housing 30. As a result of the rotation, the connecting channels 16 come into overlap with different connection openings 34 which are formed in the valve housing 30. A fluid can thus be conducted to different connection openings 34.

In order to permit the rotation of the valve body 10 in the valve housing 30, the valve body 10 has, on the upper side 11, a drive shaft 14 of which only the free end is visible in the illustration according to FIG. 1. The drive shaft 14 can have a circumferential toothing in order to produce a form-fitting and rotationally fixed connection to a drive, for example an electric motor. Proceeding from the lower side 12, an axle journal 15 extends opposite the drive shaft 14. The axle journal 15 engages in a recess 38 of the valve housing 30, wherein the axle journal 15 is rotatable in the recess 38. The axle journal 15 can form, in particular, a sliding rotary bearing with the recess 38. In any case, it is provided that there is a form fit at least in the radial direction between the axle journal 15 and the recess 38, with the result that the valve body 10 is guided well in the valve housing 30. The axle journal 15 and the drive shaft 14 are each arranged concentrically with respect to the axis of rotation 13.

The valve housing 30 has a cavity which accommodates the valve body 10, preferably completely. The valve body 10, in particular the upper side 11, comes at least partially into abutment with an inner face 33 of the valve housing 30 in the installed state. The valve housing 30 can be closed by a cover 31.

The inner face 33 of the valve housing 30 is perforated by a passage opening 35. The drive shaft 14 extends through the passage opening 35. A shaft seal 37 which surrounds the drive shaft 14 is preferably provided between the passage opening 35 and the valve body 10. The shaft seal 37 can be formed in an annular manner, in particular as an O-ring or X-ring.

The valve housing 30 furthermore comprises outer walls which, together with the inner face 33, delimit the cavity which accommodates the valve body 10. A total of four outer walls are provided which each have a connection opening 34. The connection openings 34 can each accommodate a connection piece 36. The fluid valve can be incorporated into a cooling system of a motor vehicle by means of the connection pieces 36.

The valve body 10 is also sealed with respect to the connection openings 34. In particular, a sealing arrangement 400 is assigned to each valve opening of the connecting channels 16. The sealing arrangement 400 comprises a sliding seal 40 and an elastic seal 50. The sliding seal 40 bears against the valve body 10 in the mounted state. The elastic seal 50 partially surrounds the sliding seal 40 and tensions the sliding seal 40 against the valve body 10.

The cover 31 covers the cavity of the valve housing 30 in the assembled state. The valve body 10 is thus encapsulated by the valve housing 30. The recess 38 is arranged in the cover 31, which recess can be seen in the illustration according to FIG. 1 as a bulge on the outer side of the cover 31. The bulge is supported by a plurality of substantially radially oriented gills 32. The recess 38 receives the axle journal 15 in a form-fitting manner, with the result that the valve body 10 is mounted rotatably.

The longitudinal sectional view according to FIG. 2 shows further details of the fluid valve, wherein the section runs in a plane perpendicularly to the axis of rotation 13 and along the longitudinal axes of two opposite connection openings 34 and connection pieces 36 of the valve housing 30. The valve housing 30 has a plurality of fastening extensions 39 on that side on which the drive shaft 14 of the valve body 10 emerges from the valve housing 30. The fastening extensions 39 can have holes for receiving fastening screws. The fastening extensions 39 generally permit the valve housing 30 to be connected to other components, for example an electric motor as drive for the valve body 10. It is also possible to produce a connection between the valve housing 30 and body parts of a motor vehicle by means of the fastening extensions 39.

In particular, the rotatable mounting of the valve body 10 in the valve housing 30 can be seen in FIG. 2. The axle journal 15 engages in a form-fitting manner in the recess 38 in the cover 31 of the valve housing 30, wherein a rotation about the axis of rotation 13 is still possible. In particular, the form fit preferably exists in the radial direction. By contrast, the axle journal 15 has a clearance in a direction parallel to the axis of rotation 13. In the state illustrated, two valve openings of different connecting channels 16 of the valve body 10 are oriented such that they are aligned with the connection openings 34 and connection pieces 36.

The drive shaft 14 extends through the shaft seal 37 which bears against the housing cover in the region of the passage opening 35. The shaft seal 37 seals against the drive shaft 14 which preferably has no toothing in this region, but rather a round outer circumferential face. By contrast, a toothing can be provided in a portion which projects outwards beyond the valve housing 30.

Furthermore, FIG. 2 shows the sealing arrangement 400 with the sliding seal 40 and the elastic seal 50. The sliding seal 40 bears in a sealing manner against the lateral surface of the valve body 10. The sliding seal 40 forms a ring with a substantially L-shaped cross section, wherein one leg of the L shape is formed by a pipeline section 42 and the other leg of the L shape is formed by a support flange 41. The pipeline section 42 delimits a fluid channel 60.

In the detail view according to FIG. 3, it can be seen that the support flange 41 has a chamfer 44. The chamfer 44 delimits an entry opening into the sliding seal 40, wherein the entry opening tapers owing to the chamfer 44 proceeding from a chamfer edge 44a towards the pipeline section 42. The chamfer 44 can run along a tangent to the circularly curved lateral surface of the valve body 10. In any case, it is provided that the sliding seal 40 bears with the chamfer edge 44a, in particular only with the chamfer edge 44a, against the lateral surface of the valve body 10. The contact between the valve body 10 and the sliding seal 40 therefore takes place linearly, in particular along the line of the chamfer edge 44a. Sufficient sealing between the valve body 10 and the sliding seal 40 is thus ensured and, in addition, it is achieved that the friction between the valve body 10 and the sliding seal 40 is limited in order to permit low-friction and easy rotation of the valve body 10 in the valve housing 30.

The chamfer 44 preferably runs at an angle from the chamfer edge 44a to an annular edge 44b which separates the chamfer 44 from an inner circumferential face 42a of the pipeline section 42. In this case, the angle of the chamfer 44 is selected such that the annular edge 44b is arranged at a distance from the lateral surface of the valve body 10. It is thus ensured that linear contact between the sliding seal 40 and the valve body 10 takes place merely via the chamfer edge 44a. The distance between the annular edge 44b and the valve body 10 is preferably dimensioned such that even in the case of possible wear of the chamfer edge 44a, full-surface abutment of the chamfer 44 on the valve body 10 is avoided. In particular, the distance between the annular edge 44b and the lateral surface of the valve body 10 can be at least 0.5 mm, in particular at least 0.8 mm, in particular 1 mm.

In addition, it can be seen clearly in FIG. 3 that the support flange 41 has an outer circumferential face 41c which is supported against the valve housing 30. In particular, the support flange 41 substantially forms a support against an inner circumferential face of the valve housing 30. Such a support is meaningful in this respect, since the fluid-dynamic influences when a fluid flows through the fluid valve lead to the valve body 10 being raised. In particular, the valve body 10 forces in the direction of the base of the valve body 10 or in the direction of the drive of the fluid valve. Here, the support function of the support flange 41 has an effect, which in this respect also supports the valve body 10 against the fluid pressure.

The valve body 10 does not bear with its upper side 11 over the full surface against the inner face 33 of the valve housing 30. Rather, spacers 20 are provided which provide a punctiform sliding contact between the valve body 10 and the valve housing 30. The spacers 20 are preferably formed as knobs 21 which have a curved, in particular spherically segmented, contact surface. The knobs 21 form the punctiform sliding contact.

The spacers 20, in particular the knobs 21, can be formed on the valve body 10 or on the valve housing 30. The knobs 21 can be formed monolithically with the valve body 10 or the valve housing 30. If the spacers 20 are arranged on the valve body 10, they are preferably located on the upper side 11 thereof. On the valve housing 30, the spacers 20 are preferably formed on the inner face 33. In particular, the spacers 20 can project from the inner face 33 towards the valve body 10.

In general, the spacers 20 are preferably arranged on a circular line, wherein it is preferred if the spacers 20 are positioned on the circular line in a uniformly distributed manner, i.e. at identical distances from one another. A number of at least three, but preferably an even number of at least four or more, spacers 20 has proven advantageous.

In the sectional illustration according to FIG. 3, it can be seen that the knobs 21 maintain a distance between the inner face 33 of the valve housing 30 and an upper side 11 of the valve body 10. The spherical or spherically segmented curvature of the knobs 21 here effects a punctiform contact between the respective spacer 20 or knob 21 and the upper side 11 of the valve body 10. Each spacer 20 thus forms a punctiform sliding contact. The valve body 10 can thus easily rotate about the axis of rotation 13 because the knobs 21 permit only little friction.

As can be seen in the exemplary embodiment according to FIG. 3, the valve body 10 can have a circumferential projection 17 which extends annularly around the upper side 11 and substantially continues the lateral surface of the valve body 10 beyond the upper side 11. The chamfer edge 44a of the sealing arrangement 400 preferably bears against the circumferential projection 17. The advantage of the circumferential projection 17 is that additional radial guidance of the valve body 10 in the valve housing 30 is achieved in this way. The circumferential projection 17 can engage in a circumferential recess 18 which is formed annularly in the valve housing 30. Tilting of the valve body 10 is thus avoided.

The sealing arrangement 400 can be seen particularly well in the detail illustration according to FIG. 3. The sliding seal 40 bears with the chamfer edge 44a of the support flange 41 against the valve body 10 in a sealing manner, with the result that there is a linear sealing contact. The chamfer 44 which brings about a tapering of the entry opening of the sliding seal 40 in the direction of the pipeline section 42 extends from the chamfer edge 44a.

The elastic seal 50 surrounds the pipeline section 42 of the sliding seal 40 and bears against the support flange 41. In particular, the elastic seal 50 is arranged between the support flange 41 and an inner wall 33a of the valve housing 30. The elastic seal 50 has an elastic material, with the result that the elastic seal 50 is tensioned between the support flange 41 and the valve housing 30 and therefore presses the sliding seal 40 against the valve body 10. An annularly encircling depression 51 is formed on an inner circumferential face 50a of the elastic seal 50. By contrast, an outer circumferential face 50b of the elastic seal 50 is curved outwards or has an annularly encircling curvature 52.

The annularly encircling depression 51 forms a predetermined bending point. The elastic seal 50 can therefore curve outwards in the region of the encircling depression 51 and therefore be tensioned in a spring-like manner between the support flange 41 and the valve housing 30.

The annularly encircling depression 51 and the annularly encircling curvature 52 interact in this respect in that they jointly form a predetermined bending point of the elastic seal 50. If the elastic seal 50 is compressed in the axial direction, that is to say parallel to the longitudinal axis 19, a central portion of the elastic seal 50 deflects outwards. A deflection inwards is avoided by the encircling depression 51a and the curvature. The elastic seal 50 thus curves outwards, wherein at the same time a tensioning force is generated, with which the elastic seal 50 is forced back into the original state again. This spring-like tensioning force is exerted by the elastic seal 50 when the elastic seal 50 is tensioned between the support flange 41 and an opposite inner wall 33a of the valve housing 30.

In this connection, it is pointed out that the elastic seal 30 is illustrated in its rest state in FIGS. 3 and 4 for reasons of illustration. Purely graphically, the elastic seal 50 therefore projects into the valve housing 30. In fact, however, the elastic seal 50 is compressed and bears with its outer axial end 54 against the inner wall 33a of the valve housing. When viewing FIGS. 3 and 4, it is consequently clear that the elastic seal 50 compresses, in particular curves outwards, in order to be fitted into the delimited space between the support flange 41 and inner edge 33a.

The opposite, inner axial end 53 of the elastic seal 50 is arranged in the annular groove 43. The annular groove 43 extends in an annular face 41a of the support flange 41 which faces the pipeline section 42. By receiving the inner axial end 53 of the elastic seal 50 in the annular groove 43, it is ensured that the elastic seal 50 does not curve outwards with an inner axial end 53 when it is compressed. Rather, the inner axial end 53 is secured radially by the annular groove 43, thus ensuring that the elastic seal 50 curves in the region of the predetermined bending point.

FIG. 4 shows a further variant of the fluid valve which differs from the variant described above by the configuration of the elastic seal 50. In the exemplary embodiment according to FIG. 4, the elastic seal 50 has, at its outer axial end 54 on the outer circumferential face 50b, a radially outwardly directed bead 55. The bead 55 runs over the entire circumference of the elastic seal 50. Furthermore, the inner circumferential face 50a of the elastic seal 50 is of conical configuration in the region of the outer axial end 54. In particular, the inner circumferential face 50a, proceeding from the annularly encircling recess 51, is widened conically towards the outer axial end 54 and forms a conical widening 56. This configuration has the effect that, when the elastic seal 50 is compressed such that it is tensioned into the space between the support flange 41 and the inner wall 33a of the valve housing 30, the outer axial end 54 is bent outwards, with the result that the elastic seal 50 is likewise supported on an inner circumferential face of the valve housing 30. Substantially, therefore, a support similar to that achieved with the support flange 41 in the sliding seal 40 can take place.

In FIG. 4, for reasons of illustration, the elastic seal 50 is shown such that it projects into the inner wall 33a of the valve housing 30. However, this graphical overlap does not exist in practice. Rather, the elastic seal 50 curves such that the inner axial end 53 bears against the annular groove 43, and the outer axial end 54 bears against the inner wall 33a. Here, the bead 55 can bear against an inner circumferential face of the valve body 30. In any case, the bead 55, in particular in conjunction with the conical widening 56 of the elastic seal 50, prevents the elastic seal 50 from curving into the gap between the pipeline section 43 and the inner wall 33a of the valve body 30 and thus influencing the fluid flow in an undesired manner. Rather, the bead 55 together with the conical widening 56 ensures that the elastic seal 50 remains outside the fluid flow region and thus a laminar flow is achieved in the region of the pipeline section 43 and the connection opening 34.

Moreover, within the scope of the present application, the following features of the fluid valve are disclosed which can be combined with all the abovementioned features:
1. Fluid valve for a fluid system of a motor vehicle, wherein the fluid valve has at least two connection openings 34 for the inflow and/or outflow of fluid, a valve housing 30 and a single-part or multi-part valve body 10 which is rotatable about an axial axis of rotation 13 in the valve housing 30 and has at least one connecting channel 16 for connecting at least two connection openings 34 depending on the position of the valve body 10, wherein, for sealing between the valve body 10 and the valve housing 30 in the region of the connection openings 34, a two-part sealing arrangement 400 is provided in each case, which sealing arrangement comprises a dynamic sliding seal 40 and an elastic seal 50, wherein a height/length ratio of the elastic seal 50 in the non-tensioned state is less than 0.5.
2. Fluid valve according to number 1, wherein the sliding seal 40 is provided for sealing abutment against the valve body 10 and the elastic seal 50 is provided for sealing abutment against the sliding seal 40 and the valve housing 30 or a connection piece 36 which is connected to the valve housing 30, such that the elastic seal 50 bears in a sealing manner axially between the sliding seal 40 and the valve housing 30 or a connection piece 36 which is connected to the valve housing 30 in the tensioned state.
3. Fluid valve according to number 1 or 2, wherein the sliding seal 40 is substantially L-shaped in cross section and the elastic seal 50 is substantially C-shaped in cross section.
4. Fluid valve according to one of the preceding numbers, wherein the valve body 10 is provided so as to be able to be centred via a plurality of sliding seals 40.
5. Fluid valve according to one of the preceding numbers, wherein the valve body 10, the valve housing 30 and a cover 31 which closes the valve housing 30 each have complementary means for preventing tilting of the valve body 10.
6. Fluid valve according to one of the preceding numbers, wherein the connecting channel 16 is of straight or arcuate configuration.
7. Fluid valve according to one of the preceding numbers, wherein the valve body 10 is arranged in a distributor plate, wherein connection pieces 36 for the connection openings 34 or continuing channels are provided integrated into the distributor plate.
8. Fluid device having a fluid valve according to one of the preceding numbers and an actuator, which is connected to the fluid valve, for actuating the fluid valve for a fluid system of a motor vehicle.
9. Fluid device according to number 8, wherein the actuator has an electric motor having an engine output shaft and a transmission for transmitting a torque of the engine output shaft to an actuator output wheel which is configured for actuating the fluid valve.
10. Fluid device according to number 9, wherein the actuator output wheel and a drive shaft 14 of the valve body 10 are connected in a form-fitting manner.
11. Use of a fluid device according to one of the preceding numbers as a multi-way valve.
12. Use of a fluid device according to one of the preceding numbers as a cooling water valve of a vehicle.

### REFERENCE SIGNS

10 Valve body
11 Upper side
12 Lower side
13 Axis of rotation
14 Drive shaft
15 Axle journal
16 Connecting channel
17 Circumferential projection
18 Circumferential recess
19 Longitudinal axis
20 Spacer
21 Knobs
30 Valve housing
31 Cover
32 Gill
33 Inner face
33a Inner wall
34 Connection opening
35 Passage opening
36 Connection piece
37 Shaft seal
38 Recess
39 Fastening extension
400 Sealing arrangement
40 Sliding seal
41 Support flange
42 Pipeline section
43 Annular groove
44 Chamfer
44a Chamfer edge
44b Annular edge
44c Outer circumferential face
50 Elastic seal
50a Inner circumferential face of the elastic seal
50b Outer circumferential face of the elastic seal
51 Annularly encircling depression
52 Curvature
53 Inner axial end
54 Outer axial end
55 Bead
56 Conical widening
60 Fluid channel

1. Fluid valve, in particular for a coolant circuit of a motor vehicle, having a valve body (10) which is arranged rotatably in a valve housing (30), wherein the valve housing (30) has a plurality of flow channels (34) and a sealing arrangement (400) is provided between each of the flow channels (34) and the valve body (10), which sealing arrangement comprises a sliding seal (40) and an elastic seal (50), wherein the elastic seal (50) is arranged between the valve housing (30) and the sliding seal (40) in such a way that the sliding seal (40) is tensioned against the valve body (10), characterized in that the sliding seal (40) has an L-shaped cross section with a support flange (41) and a pipeline section (42), wherein the pipeline section (42) delimits a fluid channel (60) in an annular manner and the support flange (41) extends radially outwards beyond an outer circumference of the pipeline section (42).

2. Fluid valve according to claim 1, characterized in that the support flange (41) has, on an annular face (41a) which faces the pipeline section (42), an annular groove (43) for radially securing the elastic seal (50).

3. Fluid valve according to claim 1 or 2, characterized in that the support flange (41) has a chamfer (44) with a chamfer edge (44a) which forms a linear contact with the valve body (10).

4. Fluid valve according to claim 3, characterized in that the chamfer edge (44a) is formed between the chamfer (44) and a side face (41b) of the support flange (41) facing the valve body (10).

5. Fluid valve according to claim 4, characterized in that the side face (41b) is oriented perpendicularly to a longitudinal axis (19) of the sliding seal (40).

6. Fluid valve according to one of the preceding claims, characterized in that an annular edge (44b) is formed between the chamfer (44) and an inner circumferential face (42a) of the pipeline section (42), wherein the annular edge (44b) is arranged at a distance from the valve body (10).

7. Fluid valve according to one of the preceding claims, characterized in that the support flange (41) has a radial outer circumferential face (41c) which is supported against the valve housing (30).

8. Fluid valve according to one of the preceding claims, characterized in that the elastic seal (50) surrounds the pipeline section (42) in an annular manner.

9. Fluid valve according to one of the preceding claims, characterized in that the elastic seal (50) has a predetermined bending point.

10. Fluid valve according to claim 9, characterized in that, in order to form the predetermined bending point, the elastic seal (50) has, on an inner circumferential face (50a), an annularly encircling depression (51) and/or, on an outer circumferential face (50b), an annularly encircling curvature (52).

11. Fluid valve according to one of the preceding claims, characterized in that the elastic seal (50) has, at an end which faces away from the support flange (41), a radially outwardly directed bead (55).

12. Fluid valve according to one of the preceding claims, characterized in that the inner circumferential face (50a) of the elastic seal (50) widens conically at an end which faces away from the support flange (41) and towards the valve housing (30).

13. Fluid valve according to one of the preceding claims, characterized in that the elastic seal (50) has a more elastic material than the sliding seal (40).

14. Cooling system of a motor vehicle, in particular of a preferably battery-electric passenger motor vehicle, having a fluid valve according to one of the preceding claims.

15. Motor vehicle, in particular multi-track motor vehicle, having a cooling system and/or a fluid valve according to one of the preceding claims.
